(19) United States
(12) Patent Application Publication
(10) Pub. No.: US 2004/0047283 A1
(43) Pub. Date: Mar. 11, 2004

(54) FDM signals crosstalk cancellation technique

(76) Inventors: Mark Henry Bonwick, Frenchs Forest (AU); Steve Winnall, Wollstonecraft (AU); Brian Robert Brown, Collaroy (AU); Michael Hudson, Chester Hill (AU); Ross Halgren, Collary Plateau (AU)

Correspondence Address: CHRISTIE, PARKER & HALE, LLP, P.O. BOX 7068, PASADENA, CA, 91109-7068, US

(21) Appl. No.: 10/241,052

(22) Filed: Sep. 10, 2002

(51) Int. Cl. H04J 1/12

(52) U.S. Cl. 370/201

(57) ABSTRACT

A method of cancelling crosstalk between a primary and a secondary signals contained in a FDM signal, wherein the primary signal comprises a binary encoded signal and the secondary signal has a lower signal amplitude than the primary signal, the method comprising the steps of (a) applying 2R and/or 3R regeneration to a primary signal recovery portion of the FDM signal for obtaining an estimate of the primary signal, and (b) utilising at least a portion of the estimated primary signal to substantially remove a primary signal contribution in a secondary signal recovery portion of the FDM signal for recovering the secondary signal.

### FIELD OF THE INVENTION

The present invention relates broadly to a method of cancelling crosstalk between a primary and a secondary signals contained in a frequency division multiplexed (FDM) signal, to a receiver system for a FDM signal, and to a FDM transmission link system.

### BACKGROUND OF THE INVENTION

Cancellation of crosstalk interference between two sub-carrier FDM signals transmitted together is important in a variety of communication systems, including but not limited to fibre-optic optical communication systems, free-space optical communications systems, and non-optical communications systems such as free-space radio frequency, coaxial-cable and twisted-pair communication systems.

In such systems, different motivations exist for utilising FDM signals. For example, a lower rate embedded operations channel (EOC) or optical supervisory channel (OSC) may be multiplexed with a higher rate client data stream in a single or multi-wavelength (wavelength division multiplexed, WDM) optical fibre communications system. Another example is sub-carrier FDM multiplexing of a low capacity client data stream with a high capacity data stream, such as multiplexing of legacy E1/T1 data streams with new broadband OC-n or GbE data streams in an optical communications system.

In at least preferred embodiments, the present invention seeks to provide a new method of cancelling crosstalk interference between two sub-carrier FDM signals transmitted together in a communications system.

### SUMMARY OF THE INVENTION

In accordance with a first aspect of the present invention there is provided a method of cancelling crosstalk between a primary and a secondary signals contained in a FDM signal, wherein the primary signal comprises a binary encoded signal and the secondary signal has a lower signal amplitude than the primary signal, the method comprising the steps of (a) applying 2R and/or 3R regeneration to a primary signal recovery portion of the FDM signal for obtaining an estimate of the primary signal, and (b) utilising at least a portion of the estimated primary signal to substantially remove a primary signal contribution in a secondary signal recovery portion of the FDM signal for recovering the secondary signal.

In one embodiment, step (b) comprises modifying a power level of the portion of the estimated primary signal such that maximum cancellation occurs.

Preferably, the secondary signal has a lower bandwidth than the first signal, and step (b) comprises bandpass filtering the secondary signal recovery portion of the FDM signal, applying substantially the same bandpass filtering to the portion of the estimated primary signal and utilising the filtered estimated primary signal portion to remove a primary signal contribution in the filtered secondary signal recovery portion of the FDM signal for recovering the secondary signal.

In one embodiment, the secondary signal has a lower bandwidth than the primary signal and the method comprises the step of multiplexing the primary and secondary signals to create the FDM signal, wherein the secondary signal is multiplexed with a center frequency f_{C}, and the method further comprises shifting f_{C} to a higher value to reduce jitter induced by the secondary signal in the primary signal to meet a desired performance criterion.

In one embodiment, the secondary signal has a ν % modulation index and the primary signal has a 100-ν % modulation index in the FDM signal, and the method further comprises utilising different values for ν for primary signals of different bit rates, wherein values higher than a lower limit value νₘᵢₙ for a required bandwidth of the secondary signal and a required maximum bit rate of the primary signals are used for primary signals having a bit rate lower than the maximum bit rate. The lower limit value νₘᵢₙ may be determined based on thermal noise only. The lower limit value may further be determined based on reduction in power levels along a transmission path of the FDM signal to the recovery point.

In accordance with a second aspect of the present invention there is provided a receiver system for a FDM signal containing a primary and a secondary signals, wherein the primary signal comprises a binary encoded signal and the secondary signal has a lower signal amplitude than the primary signal, the system comprising a regeneration unit for, in use, applying 2R and/or 3R regeneration to a primary signal recovery portion of the FDM signal for obtaining an estimate of the primary signal, and a crosstalk cancellation unit arranged, in use, to utilise at least a portion of the estimated primary signal to substantially remove a primary signal contribution in a secondary signal recovery portion of the multiplexed signal for recovering the secondary signal.

In one embodiment, the system further comprises an amplifier unit arranged, in use, to modify a power level of the portion of the estimated primary signal such that maximum cancellation occurs.

Preferably, the secondary signal has a lower bandwidth than the first signal, and the crosstalk cancellation unit comprises a first bandpass filter structure for filtering the secondary signal recovery portion of the multiplexed signal, and a second bandpass filter structure having substantially the same filter response as the first bandpass filter structure for filtering the portion of the estimated primary signal, and is arranged such that, in use, the filtered estimated primary signal portion is utilised to remove a primary signal contribution in the filtered secondary signal recovery portion of the multiplexed signal for recovering the secondary signal.

In accordance with a third aspect of the present invention, there is provided a FDM transmission link system comprising a transmitter system for a FDM signal containing a primary and a secondary signals, wherein the primary signal comprises a binary encoded signal and the secondary signal has a lower signal amplitude than the primary signal and the secondary signal has a ν % modulation index and the secondary signal has a 100-ν % modulation index in the FDM signal, and a receiver system comprising a regeneration unit for, in use, applying 2R and/or 3R regeneration to a primary signal recovery portion of the FDM signal to obtain an estimate of the primary signal and a crosstalk cancellation unit arranged, in use, to utilise at least a portion of the estimated primary signal to substantially remove a primary signal contribution in a secondary signal recovery portion of the multiplexed signal for recovering the secondary signal, and wherein the transmitter system is arranged, in use, to apply different values of ν for primary signals of different bit rates, wherein values higher than a lower limit value νₘᵢₙ for a required bandwidth of the secondary signal and a required maximum bit rate of the primary signals are used for primary signals having a bit rate lower than the maximum bit rate.

In one embodiment, the receiver system further comprises an amplifier unit arranged, in use, to modify a power level of the portion of the estimated primary signal such that maximum cancellation occurs.

Preferably, the secondary signal has a lower bandwidth than the first signal, and the crosstalk cancellation unit comprises a first bandpass filter structure for filtering the secondary signal recovery portion of the multiplexed signal, and a second bandpass filter structure having substantially the same filter response as the first bandpass filter structure for filtering the portion of the estimated primary signal, and is arranged such that, in use, the filtered estimated primary signal portion is utilised to remove a primary signal contribution in the filtered secondary signal recovery portion of the multiplexed signal for recovering the secondary signal.

The lower limit value νₘᵢₙ may be determined based on thermal noise. The lower limit value νₘᵢₙ may further be determined based on reduction in power levels along a transmission path of the FDM signal to the recovery point.

In one embodiment, the secondary signal has a lower bandwidth than the primary signal and the transmitter system is arranged, in use, to multiplex the primary and secondary signals to create the FDM signal, wherein the secondary signal is multiplexed with a center frequency f_{C}, and the transmitter system is further arranged, in use, to shift f_{C} to a higher value to reduce jitter induced by the secondary signal in the primary signal to meet a desired performance criterion.

### BRIEF DESCRIPTION OF THE DRAWINGS

Preferred embodiments of the present invention will now be described, by way of example only, with reference to the accompanying drawings.

FIG. 1 is a schematic drawing illustrating a point-point transmission link in an optical fibre transmission network.

FIG. 2 shows relative spectral power densities in an EOC+client data signal on a WDM channel of the transmission link of FIG. 1.

FIG. 3 is a schematic diagram illustrating a crosstalk cancellation circuit embodying the present invention.

FIG. 4 is a schematic diagram illustrating another crosstalk cancellation circuit embodying the present invention.

FIG. 5 is a schematic diagram illustrating another crosstalk cancellation circuit embodying the present invention.

FIG. 6 shows the relative spectral power density of an EOC signal+different client data signals for multiplexing onto one WDM channel (at any one time) embodying the present invention.

### DETAILED DESCRIPTION OF THE EMBODIMENTS

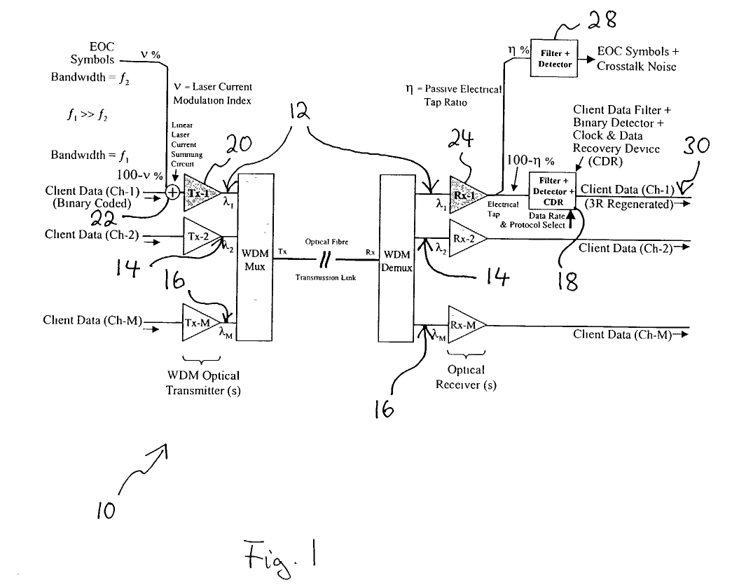

FIG. 1 illustrates a point-point uni-directional transmission link in an optical fibre transmission network. Another of these uni-directional links transmitting EOC and High Speed Data in the opposite direction would normally be added to form a bi-directional point-point link. Multiple such bi-directional links may be concatenated (daisy chained) to form a regenerative (3R—Reamplify, Reshape, Retime) bus, ring or mesh network. Alternatively, the transmission link can be bi-directional on a single fibre connection, with different wavelength channels transmitting in opposite directions along the transmission link.

FIG. 1 illustrates an example of a multi-wavelength WDM uni-directional transmission link. Only one of the wavelengths (eg, λ₁) is used to multiplex the EOC symbol stream with a High Speed (Client) Data symbol stream (numeral 12). The other WDM channels e.g. 14, 16 can carry data in any format, protocol or rate. Since they are optically (WDM) multiplexed, they do not interfere by any significant amount with the two data streams sent on the EOC/Data Channel 12.

For the EOC/Data channel 12, the Client Data stream is binary coded using a suitable coding format so that it can be transmitted through an AC-coupled network. Suitable line codes have the characteristics that: there are equal numbers of 1-symbols and 0-symbols in the data stream when averaged over a sufficiently long sequence of bits; and there is a sufficient density of transitions between different symbols (1& 0 in this case) so that a Clock/Data Recovery (CDR) device can recover the clock and the binary Data stream can be (3R) regenerated by the receiver unit 18 such that the required Bit Error Rate (BER) for the link is achieved. The binary coding process may be implemented by external client equipment (not shown) or via tributary interface cards (not shown) at the ingress to the optical fibre transmission network.

FIG. 1 shows the EOC symbols being multiplexed with the Client Data at the transmitter 20. The multiplexing method involves a process of linear addition (numeral 22) of laser drive currents proportionally attributed to each signal. The total laser drive current has lower and upper limits set respectively by its threshold current and its maximum recommended current or power. As a result of these limits, it is evident that the presence of the EOC signal (with ν % laser current modulation index) effectively reduces the maximum current and associated transmit optical power attributable to the Client Data signal (to a value 100-ν %). This has the effect of reducing the optical link margin for each signal (compared to the case where each signal would have 100% modulation index) and thus reduces the maximum transmission distance for each signal.

FIG. 1 also shows a means of demultiplexing the EOC and High Speed Data signals from the EOC/Data channel 12. This comprises a single (linear) optical receiver 24 and an electrical tap (or splitter) 26 to direct the signals to two separate noise filters and signal detectors 18, 28.

If a passive electrical tap 26 is used which splits the signal power between EOC and Data detectors 28, 18, there will be some reduction in each of the signal levels presented to each detector, which will generally reduce the sensitivity of the each detector by η % in the case of the Client Data channel and 100-η % in the case of the EOC channel (where η % is the passive electrical tap ratio for the EOC detector 28).

Other passive and active electrical tap arrangements are possible which forward the combined EOC/Data signal to both detectors 18, 28 without any significant reduction in signal level or Signal to Noise Ratio (SNR) presented to each detector 18, 28.

The two filters and detectors 18, 28 are optimized for each of the EOC and Client Data signals separately. Since the EOC bandwidth is generally much less than the Client Data bandwidth, the EOC noise filter bandwidth can be commensurately smaller than the Client Data noise filter bandwidth. Additionally, the filter response (amplitude-phase-frequency characteristic) will be optimized for the signal coding/modulation format.

For binary-coded signals such as the Client Data signal (and optionally, the EOC signal), a raised-cosine filter response is often used to minimize inter-symbol interference between symbols in the same data stream. Such a filter is generally set to have a bandwidth equal to 0.7 to 0.8 of the maximum Client Data rate to be transmitted at any time on that wavelength channel 12.

For a WDM system that is capable of transmitting at any time, any one of a range of protocols and rates, then generally, the Client Data receiver filter bandwidth and response will be optimized for the worst-case protocol and rate. In many WDM applications, this would be the SONET/SDH 2.488 Gbit/s rate for example.

It is feasible to program the Client Data receiver filter bandwidth and response to be optimal for each protocol transmitted. This in theory would extend the maximum transmission distance for lower-rate protocols. However, for WDM networks, this often provides little benefit if one of the other WDM channels is carrying a SONET/SDH 2.488 Gbit/s stream which will limit the maximum transmission distance—irrespective of the filter-optimisation for any one or more of the other channels.

As shown in FIG. 1 the Client Data signal is further processed (detected) in the filter and detector 18 to reduce the effects of highly variable signal attenuation, random (thermal) noise, systematic (pattern-dependent) noise and crosstalk (due to the EOC signal for example). This processing includes a binary detector (2R regenerator) (not shown) which regenerates the symbol shape (rise/fall time and binary signal levels) and a Clock /Data Recovery (CDR) device (3R regenerator) (not shown) which recovers the clock associated with the Client Data protocol and uses this to retime the Client Data and reduce jitter (symbol pulse width distortion). The purpose of this processing is to produce a 3R-regenerated Client Data stream at numeral 30, which meets the BER specification.

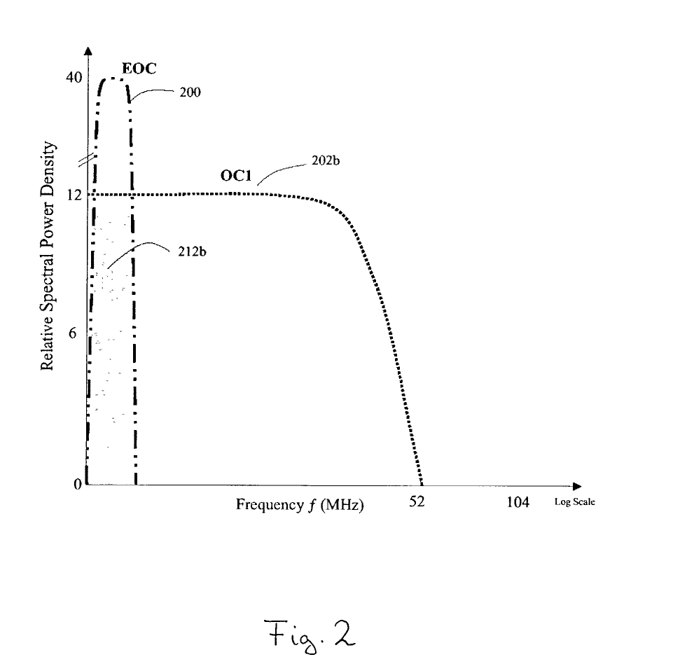

As shown in FIG. 1, the EOC filter and detector 28 will also be optimized to meet the BER requirements of the EOC channel. The detection process will differ in that the modulation format may be different (eg, FSK, PSK or QAM modulated rather than binary encoded), the symbol rate will be significantly less and the level of crosstalk from the Client Data for example may be greater. The latter will depend on the Client Data protocol and rate. An example is a 51.84 Mbit/s SONET OC1 Client Data protocol 202b, which as shown in FIG. 2, adds significant crosstalk (overlap region 212b) to a 1 Mbit/s EOC channel 200 due to significant low frequency spectral content in the OC1 stream. This low frequency content results from long strings (eg, up to 72) of Consecutive Identical Digits (CID))—a consequence of the use of a simple scrambler (as per the SONET specification) to encode the binary data stream.

FIG. 2 also highlights the difference in crosstalk that can occur between the two signals. Comparing relative power levels in the crosstalk (overlap) region 212, the SNR due to EOC crosstalk onto the OC1 Client Data signal is shown to be significantly greater than the SNR due to OC1 crosstalk onto the EOC channel. These crosstalk ratios can be adjusted by changing the modulation index (ν) at the transmitter 20 (FIG. 1). The value of ν used in FIG. 2 was 20%. Note that changing the electrical or optical tap-ratio (η) at the receiver does not affect the crosstalk. It can however, affect the receiver sensitivity and associated maximum transmission distance due to signal level, thermal noise, bandwidth and BER tradeoffs.

It is evident from the above description that it is desirable to avoid, cancel or eliminate the crosstalk between the client data and the EOC data signals for satisfactory recovery of each of those signals from the multiplexed channel signal. Most signal correlation techniques aim to extract a known signal from unknown noise. To this end, elaborate and/or low throughput encoding techniques are used. A preferred embodiment of the present invention instead applies a noise cancellation technique to remove from a EOC signal the residual Client Data noise that is within the EOC passband.

The following process summarises this cancellation technique in a preferred embodiment:

(a) Apply 2R and/or 3R correlation techniques with low modulation index to recover the binary coded Client Data signal with minimum error;

(b) Pass the relatively “clean” Client Data signal through a filter having the same bandwidth and response as the EOC path through which the EOC+Client Data signal passes;

(c) Adjust the level of the filtered Client Data signal so that when subtracted from the EOC+Client Data signal (having passed the EOC path), maximum cancellation of the Client Data signal contribution occurs. This adjustment process may simply involve a knowledge of the optical signal level at the 1R receiver input and a knowledge of the gain/losses along the EOC+Client Data path (taking the EOC receiver AGC characteristic into account if necessary).

(d) Recover the EOC signal (with Client Data substantially cancelled) using an appropriate EOC signal detector (correlator).

(e) Disable the cancellation path if Loss of Client Data Signal is detected.

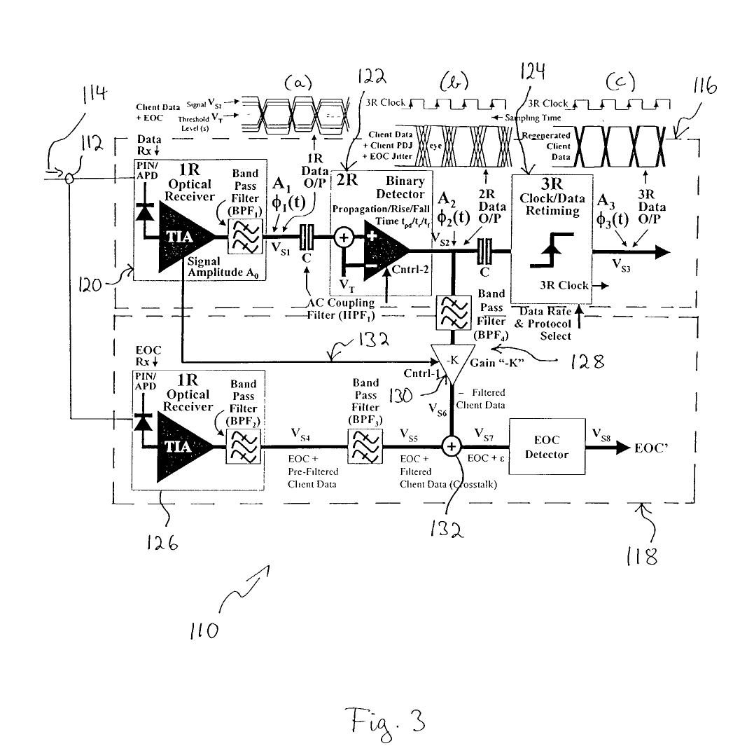

FIG. 3 shows a crosstalk cancellation circuit 1 10 embodying the present invention. In the circuit 110, an optical tap element 112 is utilised to “split” an incoming FDM client data+EOC signal (numeral 114) into a first portion directed towards a client data recovery segment 116 of the circuit 110 and a second portion directed towards an EOC recovery segment 118 of the circuit 110.

Within the client data recovery segment 116, an optical receiver unit 120 it is utilised for 1R regeneration, followed by (AC coupled) a binary detector unit 122 for 2R regeneration. This in turn is followed (AC coupled) by a clock/data retiming (CDR) unit 124 for 3R regeneration for ultimate recovery of the (regenerated) client data signal V_{S3}.

In the EOC recovery segment 118, an optical receiver unit 126 is utilised for 1R regeneration, followed by an additional bandpass filter PBF₃.

As illustrated in the inlets (a),(b),(c) in FIG. 3, the 2R regenerated Client Data signal V_{S2} is a close estimate of the original Client Data signal with minimum residual thermal and EOC crosstalk noise. Furthermore, for lower bit rate protocols (such as OC3) which cause the greatest crosstalk onto the EOC channel, the thermal and EOC induced jitter on the Client Data signal V_{S2} is fortuitously smaller. Hence the 2R regenerated lower bit-rate Client Data protocols will be “cleaner” (less noisy) and will be more effective in cancelling the Client Data noise on the EOC signal.

Signal V_{S2} is fed into a cancellation path 128 shown in FIG. 3, in which Bandpass Filter BPF₄ is designed to have the same filter response as the concatenated filters BPF₂ and BPF₃ through which the EOC+filtered Client Data signals pass in the segment 118. The cancellation path 118 also includes an adjustable level control unit 130 with absolute gain/attenuation factor K (K≧0). The value “K” is adjusted by control input (Cntrl-1) based on either the EOC or Client Data 1R optical receiver input signal amplitude (A₀). The filtered cancellation signal V_{S6} is inverted (indicated by Gain=−K) so that when added to the EOC+filtered Client Data signal V_{S5} at adder unit 132, the net result will be: V_{S7}=EOC+ε where ε is a small cancellation error.

Sources of cancellation error ε include:

(1) Filtered Client Data signal shape mismatch—due to variations in filter response;

(2) Residual jitter on the filtered Client data signal;

(3) Filtered Client Data signal amplitude mismatch—due to variations in receiver signal level measurement, gain/attenuation stage (−K) and gain/loss variations in the EOC receiver path;

(4) Delay mismatch between the Client Data receiver+regeneration+cancellation paths and the EOC receiver path for the filtered Client Data signals.

Cancellation errors (1) and (3) can be compensated for using tighter component specifications and production techniques. To a large extent, the same applies to 4) for the 2R regeneration options in the example embodiment of FIG. 1. In these cases, the Client Data path delay (t_{pd}) due to the 2R Binary Detector is relatively small (≈100 ps) for a broadband (eg, OC-48) capable system. The delays introduced by narrowband filters BPF₂, BPF₃, BPF₄, BPF₅ & BPF₆ in FIG. 3 will dominate over the broadband Binary Detector delay.

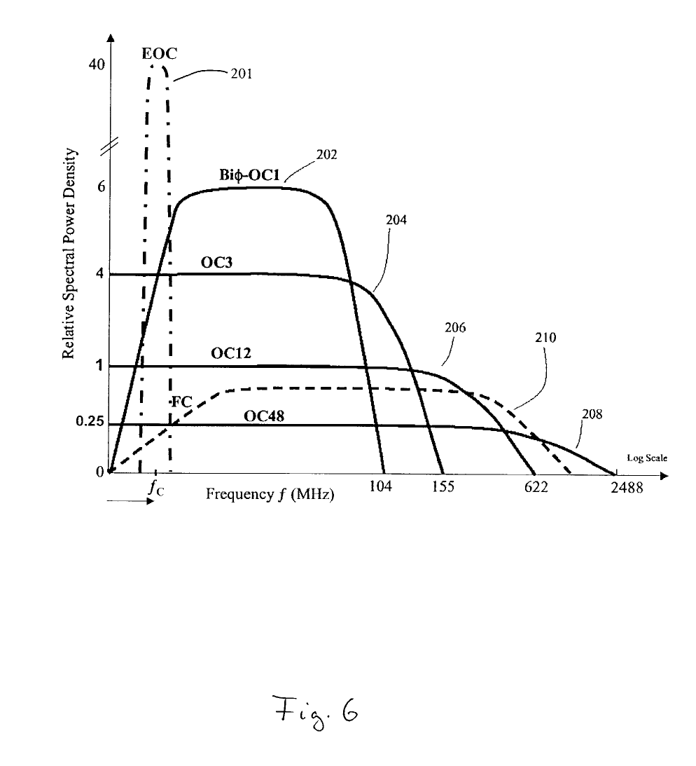

Cancellation error (2) (residual jitter) will be negligible for high enough SNR and low EOC modulation index v and/or for low bit-rate protocols such as STM1/OC3. For the case of the higher bit-rate protocols, such as STM16/OC48, the modulation index can be reduced which will compensate to a limited extent for the increased relative jitter due to the shorter bit-period. As shown in FIG. 6, the Client Data crosstalk onto the EOC signal at the OC48 rate is found to be about 1/16^{th} of the crosstalk at the OC3 rate. Consequently, a slightly increased cancellation error (2) due to jitter at the higher bit rates is less significant.

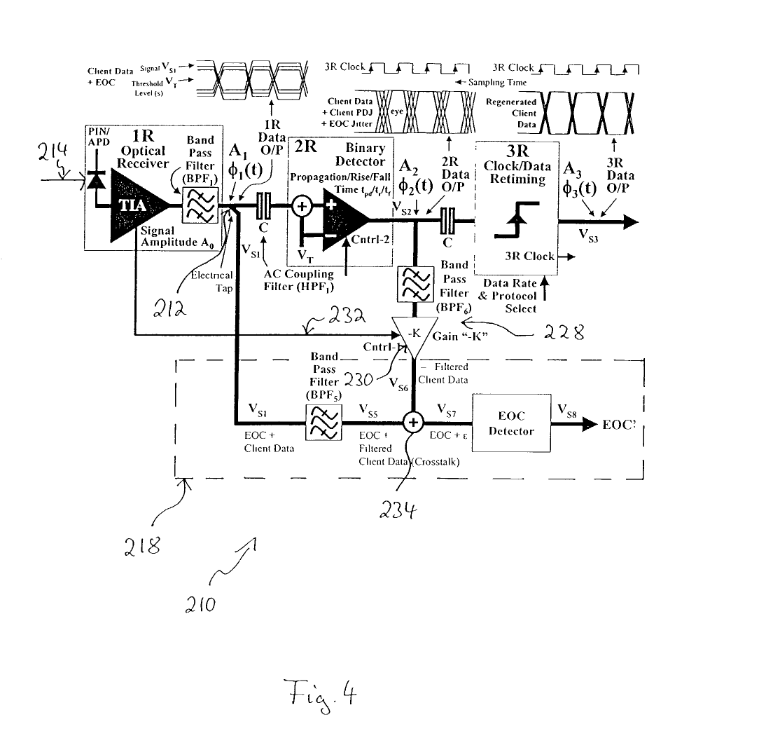

FIG. 4 shows an alternative crosstalk cancellation circuit 210 embodying the present invention. In that embodiment, an electrical tap 212 is utilised to “split” an incoming FDM multiplexed client data+EOC signal in the electrical domain at the output of an optical receiver unit 226, utilised for 1R regeneration of the incoming optical FDM signal at numeral 214.

As illustrated in the inlets (a), (b), (c) in FIG. 4, the 2R regenerated client signal V_{S2} is a close estimate of the original client data signal with minimal residual thermal and EOC crosstalk noise. Signal V_{S2} is fed into a cancellation path 228 shown in FIG. 4, in which bandpass filter BPF₆ is designed to have the same filter response as the bandpass filter BPF₅ in the EOC recovery segment 218.

The cancellation path 228 also includes an adjustable level unit 230 with absolute gain/attenuation factor K (K≧0). The value “K” is adjusted by control input 232 based on the EOC plus client data 1R optical receiver input amplitude (A₀). The filter cancellation signal V_{S6} is inverted (indicated by −K) so that when added to the EOC+filtered client data signal V_{S5} at add unit 234 the net result will be: V_{S7}=EOC+ε, where ε is a small cancellation error.

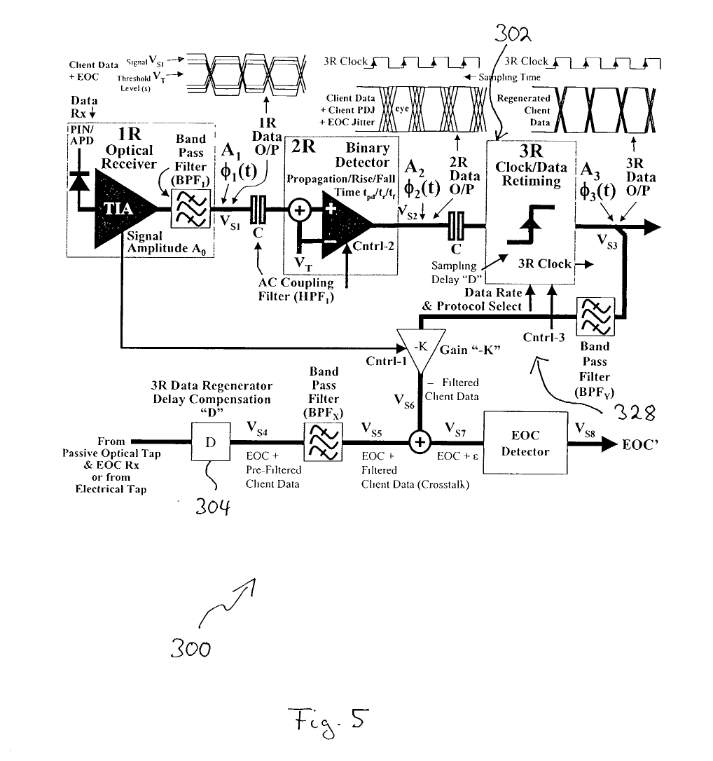

FIG. 5 shows another circuit 300 embodying the present invention for further reducing cancellation error (2) above—especially at the higher Client Data bit rates—by using the 3R regenerated signal V_{S3} as the source of Client Data in the cancellation path 328. This figure is generic to both optical and electrical tap options (compare FIGS. 3 and 4). A disadvantage of using the 3R regenerated Client Data signal for the cancellation method is the bit-rate dependent delay introduced by the CDR unit 302. A delay compensation unit 304 is used as shown in FIG. 5 to address that disadvantage. The delay “D” must be programmable to equal typically half a bit-period. Furthermore, any mismatch in the compensation delay “D” will increase the cancellation error (4) above. Again, BPF_{Y} and bandpass filter BPF_{X} have substantially the same filter response.

As shown in FIGS. 3 and 4, there is a Control Input “Cntrl-2” to the 2R regenerator. In the case of FIG. 5, Cntrl-3 may be used instead. These Control Inputs are used to force the Client Data signal V_{S2}/V_{S3} and the filtered Client Data signal V_{S6} to zero when Loss of Client Data Signal is detected, so that the cancellation process is effectively disabled as per Process step (e) of the cancellation technique embodying the present invention outlined above.

A person skilled in the art will appreciate that there are several other means of disabling the cancellation process, such as applying a disable control line to the gain/attenuation stage in the cancellation path so that K=0 when disabled.

There are several means of detecting Loss of Client Data Signal (eg, insufficient power in the Client Data passband measured with a filter that excludes the EOC passband; Loss of CDR Lock, Client Data BER Performance Monitoring, etc).

Process step (e) is preferable to prevent the EOC signal from cancelling itself out in cases where the Client Data signal disappears for some reason (eg, not yet provisioned for that wavelength or has failed at the source). It is important that the EOC channel continue to operate during either the presence or absence of a Client Data signal on the EOC/Data channel.

Thermal noise analysis has shown that an EOC modulation index ν as low as 1% is possible for a 1 Mbit/s binary encoded EOC signal in a broadband OC48 system.

Using a Client Data crosstalk cancellation method embodying the present invention, it is now feasible to design a Subcarrier FDM multiplexed EOC+Client Data transmission system for which the laser current modulation index ν (and receiver tap ratio η if applicable) are optimized in terms of the thermal noise performance of the system. It is no longer necessary to increase the modulation index ν to reach a compromise between EOC crosstalk onto Client Data and Client Data Crosstalk onto EOC.

Subject to the practical limitations of cancellation error compensation (refer (1) to (4) above, it is now possible to design an EOC/Data channel with a very low modulation index (as low as 1% for the examples given here).

Additionally, when used in conjunction with the Client Data encoding methods described in U.S. patent application Ser. No. 10/145590 entitled “Jitter control in optical network”, filed on May 13, 2002 assigned to the assignee of the present application, and U.S. patent application Ser. No. 10/160987 entitled “Optical network management”, filed on May 31, 2002, and assigned to the assignee of the present application, the present invention can cause a shift downward of the threshold level that determines when a Client Data signal should be encoded or not. Alternatively, for the same threshold level, the present invention can permit higher data throughputs for the EOC channel (>1 Mbit/s for example).

It is noted that, the modulation/coding format of the EOC channel has not been limited in any way (although binary coded examples have been used). The present invention does not restrict the EOC modulation or coding format, symbol rate or sub-carrier frequency passband in which the EOC channel resides.

One of the performance improvement benefits which can be provided is reduced EOC induced pulse-width jitter in the Client Data at high bit rates. This is achieved where the modulation index ν can be reduced to a very small value. The extent to which the modulation index ν can be reduced will depend on the practical limits to the cancellation error compensation (for cancellation errors (1) to (4) above).

The higher EOC induced pulse-width jitter for the STM16/OC48 protocol and bit-rate results from the EOC frequency passband falling within the section of the CDR loop filter jitter transfer function where there is either no jitter attenuation, or worse—there is jitter gain.

The present invention now offers the opportunity to shift the center-frequency of the EOC passband to a higher frequency where any resultant jitter will certainly be attenuated by the CDR (ie, above 2 MHz in the STM16/OC48 case).

FIG. 6 shows how the EOC passband 201 can be shifted to a higher center frequency ƒ_{C} with no increase in crosstalk from the Client Data (e.g. 202, 204, 206, 208 or 210) onto the EOC. Note that FIG. 6 does not show the reduced modulation index ν that is now possible. With reduced modulation index v and crosstalk cancellation, it will be possible to further reduce the pulse-width jitter of the Client Data signal.

Another advantage of this ability to frequency shift the EOC signal spectrum is that for the electrical tap option (compare e.g. FIG. 3), the Client Data optical receiver filter BPF₁ no longer needs to extend down to very low frequencies. The lowest frequency that it will need to pass will be determined by the lowest bit-rate protocol with the longest string of Consecutive Identical Digits (CID). It will not be determined by the lowest frequencies that the EOC channel needs to pass.

The present invention can provide the following example optimization and improvement methods and the following example procedure for managing them:

i) For the required EOC channel bandwidth and the required maximum Client Data bit rate, determine the smallest value of EOC modulation index νₘᵢₙ that is possible based on a thermal noise analysis alone (ie, no crosstalk).

ii) Apply the Client Data crosstalk cancellation method with a value of ν that is as small as possible (but no smaller than νₘᵢₙ) within the practical limits of the cancellation errors attributable to imperfect filter designs, imperfect amplitude matching, imperfect delay matching and imperfect jitter removal.

iii) Within the bounds set by i), ii) above, apply a variable EOC modulation index ν, which provides maximum performance for the Client Data bit rate being transmitted. For example, depending on the receiver design, slightly higher values of ν can be used for the lower Client Data bit rates, when these bit rates have slightly better receiver sensitivity.

iv) If the total input power to the receiver is to be split such that the signals sent to the EOC and Client Data receivers/filters/detectors are reduced in level (eg, due to a optical tap with tap ratio η), then this signal level reduction must be taken into account when determining the EOC modulation index ν.

If the above methods result in acceptable performance for the EOC and Client Data channels, then nothing more needs to be done.

v) If the performance is not acceptable and there is excessive EOC-induced pulse-width jitter, then frequency-shift the EOC band to a higher center frequency ƒ_{C} to reduce the EOC-induced jitter on the Client Data signal.

vi) If the performance is still not acceptable, then identify a threshold below which the Client Data signals must be encoded to reduce the crosstalk with the EOC channel.

There is nothing about the present invention that restricts the lower-bandwidth “secondary” channel to be used for EOC applications only. The secondary channel can transport data in any format for any low-capacity (narrowband) application. In fact, the present invention permits greater bandwidth to be allocated to the secondary channel than is normally the case, since the secondary channel modulation index v can be made very small (so as not to interfere with the primary broadband data channel) and yet still achieve reasonable performance in the presence of broadband data.

Given this, other applications of the present invention include, but are not limited to:

1) Low incremental-cost multiplexing of legacy narrowband services (such as 2.048 Mbit/s E1 or 1.544 Mbit/s T1) and new broadband services (such as OC1-OC48, Gigabit Ethernet and Fibre Channel) onto the same wavelength channel (in a single wavelength optical fibre link or network) or on multiple channels (in a WDM optical fibre link or network). The new broadband services are transported through one or more broadband channels (one per wavelength) each of which supports multiple client protocols and bit rates.

2) As for 1), but for other optical transmission media other than fibre-optic. Free-space optical communications is an example.

3) As for 1), but for other transmission media, other than optical, such as microwave radio, coaxial cable and twisted-pair. In these applications, simply equate wavelength channel to frequency channel.

The present invention can enable more degrees of freedom in terms of optimizing the performance of a two-channel sub-carrier FDM system.

The present invention can avoid/reduce, crosstalk tradeoffs from primary to secondary and secondary to primary signals which constrain the modulation index and/or require the use of a lower throughput secondary channel and/or require the use of power-consuming encoding of the primary signal for protocols and bit-rates below some threshold.

The present invention has wide application. Whilst it was designed to solve an EOC/Data crosstalk problem, it can also be applied to many other narrowband/broadband signal multiplexing applications and transmission media, such as E1/T1 with OC-n, Gigabit Ethernet and Fibre Channel for example.

For example, it could be used to upgrade existing narrowband Digital Loop Carrier (DLC) networks which multiplex narrowband (POTS) telephony channels into E1/T1 streams with additional capacity to support new broadband services such as multiple ADSL channels multiplexed into a single ATM/OC-n stream (per wavelength or frequency carrier) or multiple VDSL channels multiplexed into a single Gigabit Ethernet stream (per wavelength or frequency carrier).

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. A method of cancelling crosstalk between a primary and a secondary signals contained in a FDM signal, wherein the primary signal comprises a binary encoded signal and the secondary signal has a lower signal amplitude than the primary signal, the method comprising the steps of:
(a) applying 2R and/or 3R regeneration to a primary signal recovery portion of the FDM signal for obtaining an estimate of the primary signal, and
(b) utilising at least a portion of the estimated primary signal to substantially remove a primary signal contribution in a secondary signal recovery portion of the FDM signal for recovering the secondary signal.

2. A method as claimed in claim 1, wherein step (b) comprises modifying a power level of the portion of the estimated primary signal such that maximum cancellation occurs.

3. A method as claimed in claim 1, wherein the secondary signal has a lower bandwidth than the first signal, and step (b) comprises:
bandpass filtering the secondary signal recovery portion of the FDM signal,
applying substantially the same bandpass filtering to the portion of the estimated primary signal and
utilising the filtered estimated primary signal portion to remove a primary signal contribution in the filtered secondary signal recovery portion of the FDM signal for recovering the secondary signal.

4. A method as claimed in claim 1, wherein the secondary signal has a lower bandwidth than the primary signal and the method comprises the step of multiplexing the primary and secondary signals to create the FDM signal, wherein the secondary signal is multiplexed with a center frequency f_{C},
and the method further comprises shifting f_{C} to a higher value to reduce jitter induced by the secondary signal in the primary signal to meet a desired performance criterion.

5. A method as claimed in claim 1, wherein the secondary signal has a ν % modulation index and the primary signal has a 100-ν % modulation index in the FDM signal, and the method further comprises:
utilising different values for ν for primary signals of different bit rates,
wherein values higher than a lower limit value νₘᵢₙ for a required bandwidth of the secondary signal and a required maximum bit rate of the primary signals are used for primary signals having a bit rate lower than the maximum bit rate.

6. A method as claimed in claim 5, wherein the lower limit value νₘᵢₙ is determined based on thermal noise.

7. A method as claimed in claim 6, wherein the lower limit value νₘᵢₙ is further determined based on reduction in power levels along a transmission path of the FDM signal to the recovery point.

8. A receiver system for a FDM signal containing a primary and a secondary signals, wherein the primary signal comprises a binary encoded signal and the secondary signal has a lower signal amplitude than the primary signal, the system comprising:
a regeneration unit for, in use, applying 2R and/or 3R regeneration to a primary signal recovery portion of the FDM signal for obtaining an estimate of the primary signal, and
a crosstalk cancellation unit arranged, in use, to utilise at least a portion of the estimated primary signal to substantially remove a primary signal contribution in a secondary signal recovery portion of the multiplexed signal for recovering the secondary signal.

9. A system as claimed in claim 8, wherein the system further comprises an amplifier unit arranged, in use, to modify a power level of the portion of the estimated primary signal such that maximum cancellation occurs.

10. A system as claimed in claim 8, wherein the secondary signal has a lower bandwidth than the first signal, and the crosstalk cancellation unit comprises:
a first bandpass filter structure for filtering the secondary signal recovery portion of the multiplexed signal, and
a second bandpass filter structure having substantially the same filter response as the first bandpass filter structure for filtering the portion of the estimated primary signal,
and is arranged such that, in use, the filtered estimated primary signal portion is utilised to remove a primary signal contribution in the filtered secondary signal recovery portion of the multiplexed signal for recovering the secondary signal.

11. A FDM transmission link system comprising:
a transmitter system for a FDM signal containing a primary and a secondary signals, wherein the primary signal comprises a binary encoded signal and the secondary signal has a lower signal amplitude than the primary signal and the secondary signal has a ν % modulation index and the secondary signal has a 100-ν % modulation index in the FDM signal, and
a receiver system comprising:
a regeneration unit for, in use, applying 2R and/or 3R regeneration to a primary signal recovery portion of the FDM signal to obtain an estimate of the primary signal and
a crosstalk cancellation unit arranged, in use, to utilise at least a portion of the estimated primary signal to substantially remove a primary signal contribution in a secondary signal recovery portion of the multiplexed signal for recovering the secondary signal,
and wherein the transmitter system is arranged, in use, to apply different values of ν for primary signals of different bit rates, wherein values higher than a lower limit value νₘᵢₙ for a required bandwidth of the secondary signal and a required maximum bit rate of the primary signals are used for primary signals having a bit rate lower than the maximum bit rate.

12. A system as claimed in claim 11, wherein the receiver system further comprises an amplifier unit arranged, in use, to modify a power level of the portion of the estimated primary signal such that maximum cancellation occurs.

13. A system as claimed in claim 11, wherein the secondary signal has a lower bandwidth than the first signal, and the crosstalk cancellation unit comprises:
a first bandpass filter structure for filtering the secondary signal recovery portion of the multiplexed signal, and
a second bandpass filter structure having substantially the same filter response as the first bandpass filter structure for filtering the portion of the estimated primary signal,
and is arranged such that, in use, the filtered estimated primary signal portion is utilised to remove a primary signal contribution in the filtered secondary signal recovery portion of the multiplexed signal for recovering the secondary signal.

14. A system as claimed in claim 11, wherein νₘᵢₙ is determined based on thermal noise.

15. A system as claimed in claim 14, wherein the lower limit value νₘᵢₙ is further determined based on reduction in power levels along a transmission path of the FDM signal to the recovery point.

16. A system as claimed in claim 11, wherein the secondary signal has a lower bandwidth than the primary signal and the transmitter system is arranged, in use, to multiplex the primary and secondary signals to create the FDM signal, wherein the secondary signal is multiplexed with a center frequency f_{C},
and the transmitter system is further arranged, in use, to shift f_{C} to a higher value to reduce jitter induced by the secondary signal in the primary signal to meet a desired performance criterion.
